(19) United States
(12) Patent Application Publication
(10) Pub. No.: US 2024/0257638 A1
(43) Pub. Date: Aug. 1, 2024

(54) TRAFFIC VOLUME ESTIMATION USING APPROACHING VEHICLE DATA

(71) Applicant: DENSO International America, Inc., Southfield, MI (US)

(72) Inventors: Rajesh MALHAN, Troy, MI (US); Mahdi BANDEGI, Ann Arbor, MI (US); Oscar CROWLEY, Ann Arbor, MI (US); Patrick BODUN, Placentia, CA (US)

(73) Assignee: DENSO International America, Inc., Southfield, MI (US)

(21) Appl. No.: 18/388,225

(22) Filed: Nov. 9, 2023

Related U.S. Application Data
(60) Provisional application No. 63/442,166, filed on Jan. 31, 2023.

(51) Int. Cl. G08G 1/08; G08G 1/01

(52) U.S. Cl. CPC G08G 1/08; G08G 1/0125

(57) ABSTRACT

The systems and methods of the present disclosure provide accurate traffic volume estimates at intersections using data available from a subset of the total vehicles and can effectively resolve the issue with a low penetration rate of connected vehicles and can be used to optimize traffic lights at intersections. The systems and methods of the present disclosure use vehicle trajectory data to calculate arrival times at intersections and, from this data, use a statistical method to estimate the traffic volume. Traffic arriving at the intersection can be modeled by a distribution and then, using an algorithm, the likelihood of the observed data (limited approaching vehicles data) can be maximized. The parameters from the optimized model can be used to estimate the real traffic volume. The systems and methods of the present disclosure use a Gaussian Mixture Model (GMM) distribution to model incoming vehicles.

### CROSS-REFERENCE TO RELATED APPLICATIONS

This application claims priority to and the benefit of U.S. Provisional Application No. 63/442,166 filed on Jan. 31, 2023. The disclosure of the above application is incorporated herein by reference.

### BACKGROUND

This section provides background information related to the present disclosure which is not necessarily prior art.

Traffic volume estimation is used by traffic signal controllers to optimize traffic signal timing and reduce congestion. Limited access to time-location data of approaching vehicles makes it difficult to use the current signal optimization solutions. Further, traditional roadside sensors may communicate only partial or incomplete data regarding approaching vehicles due to device failure, improper installation, poor weather, or any number of similar scenarios. The present disclosure is directed towards estimating traffic volume using limited, partial, or incomplete data from approaching vehicles that can further be used in traffic management systems.

### SUMMARY

This section provides a general summary of the disclosure, and is not a comprehensive disclosure of its full scope or all of its features.

According to a first aspect of the present disclosure, there is provided a method for traffic volume estimation using approaching vehicle data. The method includes using an arrival traffic model to predict an arrival pattern of vehicles within a cycle, applying an Expectation Maximization algorithm to the arrival traffic model at each cycle, and determining an optimal timing model of the traffic signal based on the arrival traffic model and the applied Expectation Maximization algorithm. The traffic signal is then controlled based on the optimal timing model.

According to the first aspect, the arriving vehicles may be arriving at an intersection.

According to the first aspect, the arrival traffic model may include a Gaussian Mixture Model that provides a continuous representation of probability.

According to the first aspect, the cycle may be a red cycle determined by the length of time that the traffic light displays a red light, or a green cycle determined by the length of time that the traffic light displays a green light.

According to the first aspect, the arrival traffic model may further include consideration for time of day, peak hours, and off-peak hours.

According to the first aspect, applying the Expectation Maximization algorithm comprises an expectation step and a maximization step.

According to a second aspect of the present disclosure, there is provided a system for traffic volume estimation using approaching vehicle data. The system includes using an arrival traffic model to predict an arrival pattern of vehicles within a cycle, applying an Expectation Maximization algorithm to the arrival traffic model at each cycle, and determining an optimal timing model of the traffic signal based on the arrival traffic model and the applied Expectation Maximization algorithm. The traffic signal is controlled based on the optimal timing model.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a graph illustrating a distribution of arrival times at an intersection.

FIG. 2 is a sample Gaussian Mixture distribution (one dimensional) with two normal distribution components.

FIG. 3 depicts an intersection in accordance with the systems and methods of the present disclosure.

FIG. 4 is a block diagram of various devices and systems of a roadway system in accordance with the teachings of the present disclosure.

FIG. 5 is a flow chart for a method for generating a model in accordance with the system and methods of the present disclosure.

FIG. 6 is a flow chart for the maximization step of FIG. 5 in accordance with the system and methods of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In the systems and methods of the present disclosure, the arrival of vehicles at, for example, an intersection during each cycle of a traffic signal is considered as a probability distribution. Also, the expectation of arrivals is derived based on a distribution assumption and an Expectation Maximization (EM) method is used to find the unknown parameter that best fits the data. With the trained parameters, the systems and methods of the present disclosure can then use the vehicle arrivals (a fraction of total vehicles) to estimate the true traffic volume.

The systems and methods of the present disclosure utilize different types of traffic data to estimate the traffic volume at the intersection level.

The statistical model presented in the present disclosure uses two types of distribution to accurately model the pattern embedded within traffic with respect to time and other possible conditions.

The systems and methods of the present disclosure use a Gaussian Mixture Model for modelling vehicle arrival during a cycle to provide a continuous representation of probability that can more efficiently fit the real data, as compared with previous frequency representations. The continuous representation provides flexible probabilities for arrivals of vehicles for any input data, contrary to a frequency model that could return a zero probability in a case where the partial data does not cover the full length of a cycle.

The proposed model of the present disclosure uses the arrival traffic model within a cycle of a traffic signal to predict the arrival pattern at each time using preferred techniques, such as Expectation Maximization.

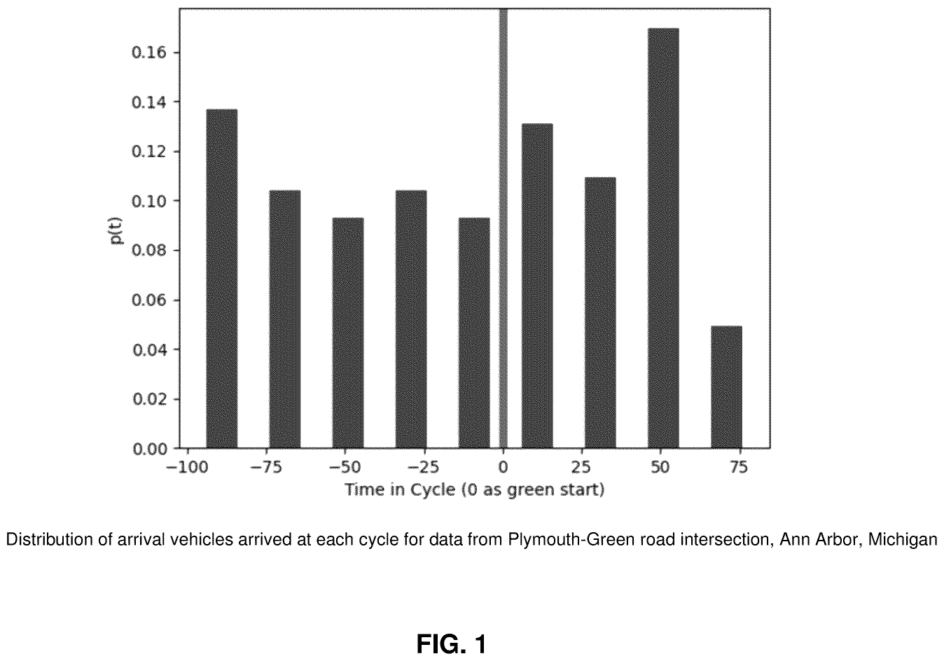

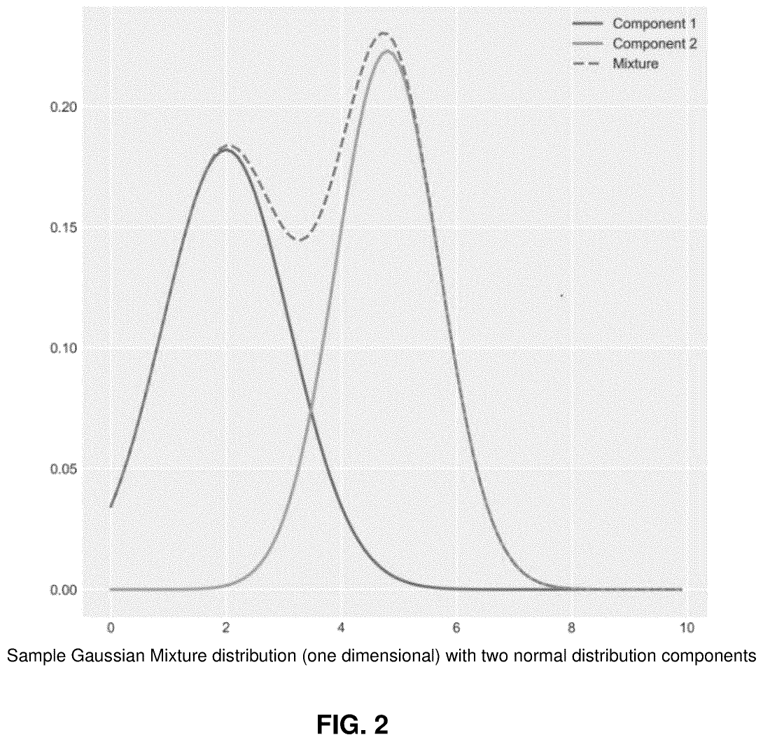

With reference to the figures, FIG. 1 illustrates the arrival distribution during a cycle from real data collection. As illustrated in FIG. 1, the distribution looks like a Gaussian Mixture (see FIG. 2). The data can be considered as a combination of at least two normal distributions representing arrival of vehicles during green and red light cycles of the traffic signal. This is a better fit than the Poisson distribution typically used in traffic analysis and recent research. Using multiple Gaussian models provides a customized distribution for vehicle arrivals in a cycle during different hours, as compared to other distributions, which effectively increases the accuracy of the estimation by considering differences in vehicle arrivals during peak hours and off-peak hours.

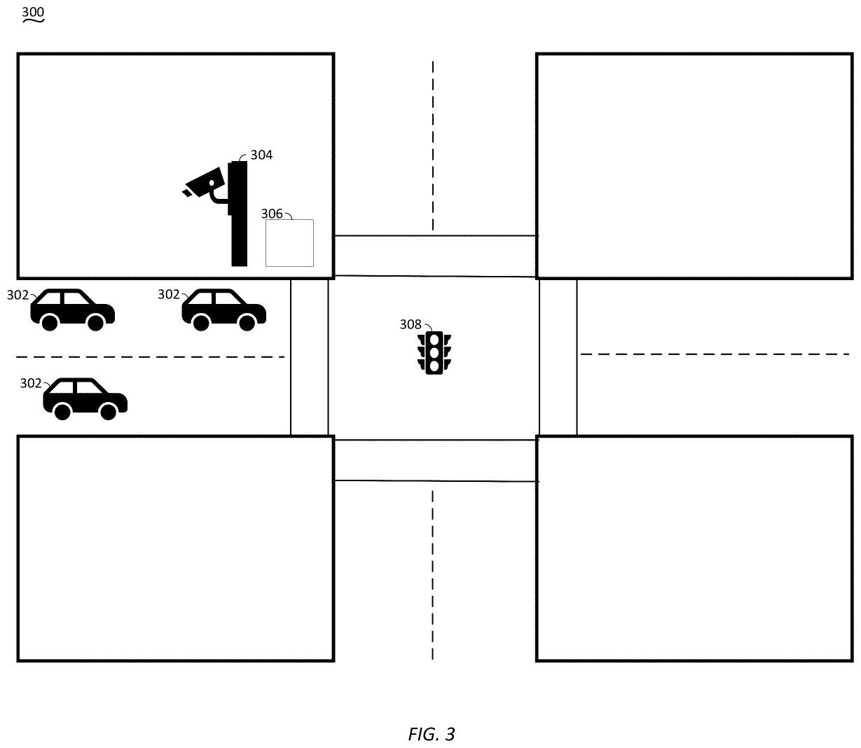

Referring to FIG. 3, an example intersection 300 is shown. The intersection generally includes approaching vehicles 302, a plurality of sensors 304, a roadside unit 306, and at least one traffic light 308 associated with Signal Phase and Timing (SPaT) data.

In one form, the traffic volume estimating unit is a roadside unit 306 at or near the intersection. The roadside unit 306 may receive sensor data and/or SPaT data from a communication module (discussed further below) via wired or wireless communication. The roadside unit 306 may be an edge subsystem, which may offload some portion of the traffic volume estimation calculations and processing to a remote server and/or cloud server.

While FIG. 3 illustrates the roadside unit 306 at the intersection, in one form, traffic volume estimation can occur at a remote location by a remote traffic volume estimating unit. The traffic volume estimating unit at the remote location can include, for example, at least the processor, memory, and communication module depicted in the roadside unit 306 in FIG. 3. Sensors 304 and SPaT communication devices may communicate directly with the traffic volume estimating unit at the remote location via wireless communication. In one form, the sensors 304 and SPaT communication devices may communicate indirectly with the traffic volume estimating unit at the remote location via the cloud.

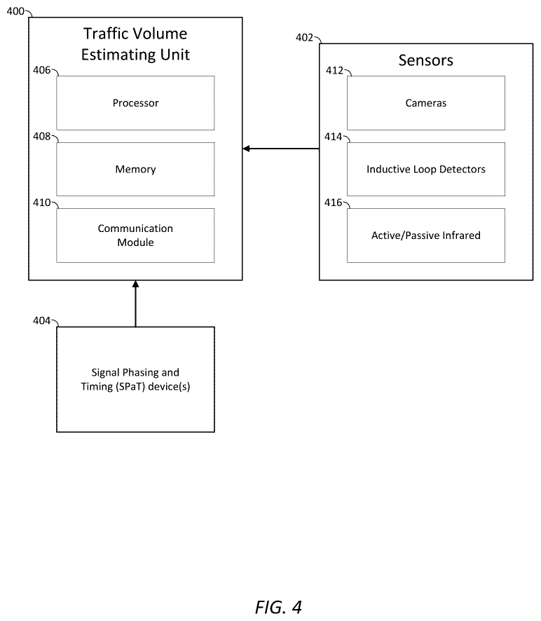

In one form, sensors 304 can include inductive loop detectors, passive or active infrared sensors, ultrasonic detectors, microwave radar detectors, video image processors, acoustic sensors, radar sensors, LIDAR sensors, and/or other traffic sensors known in the art. The sensors 304 can communicate data regarding approaching vehicles 302 to the communication module of the traffic volume estimation unit 400 (shown in FIG. 4).

Referring to FIG. 4, a block diagram of the traffic volume estimation unit 400, sensors 402, and SPaT devices 404 are depicted. In one form, the traffic volume estimating unit includes a processor 406, memory 408, and a communication module 410.

In one form, the communication module 410 includes one or more transceivers, radio circuits, amplifiers, and/or modulation circuits for communicating with SPAT devices, sensors, traffic signals, and other devices at the intersection. The communication module may communicate with sensors 402 and SPaT devices 404.

In one form, the sensors 402 may include inductive loop detectors 414, passive or active infrared sensors 416, ultrasonic detectors, microwave radar detectors, video image processors 412, acoustic sensors, radar sensors, LIDAR sensors, and/or other traffic sensors known in the art. Sensors may communicate data regarding approaching vehicles 302 to the communication module 410 of the traffic volume estimation unit 400.

In one form, SPAT devices 404 may communicate data regarding traffic signal status, traffic signal phase ID, and message timestamps to the communication module of the traffic volume estimation unit 400.

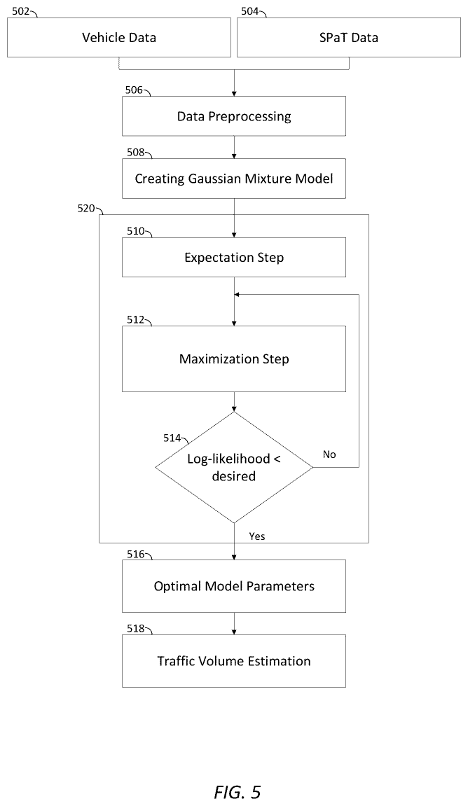

Referring to FIG. 5, an example traffic volume estimation algorithm is shown. Details and/or examples regarding each of the steps are provided above.

At 502 and 504, vehicle data and SPaT data are gathered. The vehicle data may be gathered from vehicles 302 arriving at or approaching an intersection. The vehicle data may be gathered from a subset of vehicles arriving at or approaching an intersection. The vehicle data may include vehicle trajectory information. The SPaT data may include information regarding traffic signal status, traffic signal phase ID, and message timestamps.

At 506, the vehicle data and SPaT data are preprocessed into a dataset including arrival times, departure times, and time in cycle for each vehicle. By way of example, data preprocessing may include converting vehicle data and/or SPaT data into uniform metrics, such as the number of seconds or minutes since the beginning of the cycle. This transformation facilitates the computation of intervals or gaps between successive vehicle arrivals. If the intersection has multiple lanes or directions, the data for each lane or direction may be segregated to account for potentially different traffic patterns. By way of further example, a left-turning lane might experience different traffic densities than a straight-through lane, especially during specific times of the day. Preprocessing the data may further include data normalization remove any unwanted noise or outliers. A normalization step may ensure that the Gaussian Mixture Model modeling process of step 508 captures the primary patterns of interest.

The traffic volume estimation algorithm may include a further step (not shown) of feature extraction following preprocessing. In this step, meaningful features capturing the underlying traffic patterns are extracted from the vehicle data and SPaT data. Extracted features may include the gap in time between consecutive vehicle arrivals, which are representative of the intervals at which vehicles approach the intersection. These extracted features may then be used to reveal the peak and off-peak traffic patterns of the intersection. These extracted features may further be calculated for each lane and direction to reveal directional and lane-specific trends. Additionally, descriptive statistics such as the mean, median, and variance of these intervals can offer insight into the regularity and variability of traffic flow.

At 508, a Gaussian Mixture Model is created from the preprocessed dataset of arriving vehicles 302. A Gaussian Mixture Model is a probabilistic model composed of multiple Gaussian distributions. By modelling vehicle arrival data during a cycle with a Gaussian Mixture Model, a continuous representation of probability is provided that can efficiently fit the real data, as compared to previous frequency representations. Moreover, the continuous representation provides flexible probabilities for arrivals of vehicle for any input data, contrary to a frequency model that might return zero probability in a case where the partial data does not cover the full length of a cycle.

The Gaussian Mixture Model may be divided into two steps, illustrated in FIG. 5 at 510 and 512.

### (A) Mixture Model for Vehicle Arrival at Intersection

At 510, real data shows that the arrival distribution can be modeled as a combination of multiple Gaussian distributions. Assuming the data as X1, X2, X3, . . . , and Xn as the vehicle trajectories of n vehicles arriving at the junction. The probability of Xi being a member of our distribution, considering two component model of the mixture model, can be written as follows:

$$P ( {X}_{i} = x ) = {\sum }_{k = 1}^{m} P ( {X}_{i} = x \vert {Z}_{i} = k ) P ( {Z}_{i} = k ) , \qquad ( Equation 1 )$$

where k ∈{1, 2, . . . , m} represents the number of components in each cycle, and Zi ∈{1, 2, . . . , m} indicates which components Xi came from.

The model assumes that the Gaussian distribution and Equation 1 can be simplified as:

$$P ( {X}_{i} = x ) = {π}_{1} N ( {X}_{i} \vert {μ}_{1} , {σ}_{1} ) + {π}_{2} N ( {X}_{i} \vert {μ}_{2} \vert {σ}_{2} ) + … + {π}_{m} N ( {X}_{i} \vert {μ}_{m} , {σ}_{m} ) , where {π}_{1} = P ( {Z}_{i} = 1 ) , {π}_{2} = P ( {Z}_{i} = 2 ) , and {π}_{m} = P ( {Z}_{i} = m ) . \qquad ( Equation 2 )$$

The unknown parameters in the proposed method are π₁, μ₁, σ₁, π₂, μ₂, σ₂, . . . , πₘ, μₘ, σₘ.

Further, the example traffic volume estimation algorithm may leverage criteria like the Bayesian Information Criterion or the Akaike Information Criterion to find the optimal number of distributions for the Gaussian Mixture Model. By fitting the Gaussian Mixture Model with varying numbers of distributions and then evaluating the resultant Bayesian Information Criterion or Akaike Information Criterion scores, the model that best balances goodness-of-fit with model complexity may be identified. Generally, the lower the Bayesian Information Criterion or Akaike Information Criterion score, the better the model's trade-off between fit and simplicity.

### (B) Expectation Maximization for Gaussian Mixture Model

At 512, the joint probability of observation X1, X2, X3, . . . , Xn IS:

$$P ( {X}_{1} = {x}_{1} , {X}_{2} = {x}_{2} , … , {X}_{n} = {x}_{n} ) = {\prod }_{i = 1}^{n} {\sum }_{k = 1}^{m} {π}_{k} N ( {x}_{i} \vert {μ}_{k} , {σ}_{k} ) \qquad ( Equation 3 )$$

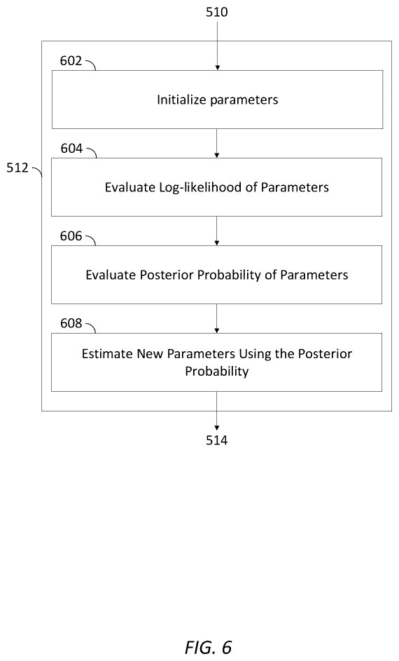

Equation 3 represents the likelihood of observing the given data and this step of the expectation maximization algorithm 520 can be used to maximize this likelihood. FIG. 6 describes maximization step 512 in further detail.

At 602, the parameters πₖ, μₖ, and σₖ are initialized.

At 604, the log-likelihood of the parameters are evaluated.

At 606, the posterior probability of the parameters is evaluated.

At 608, new parameters πₖ, μₖ, and σₖ are determined using the posterior probability.

Returning to FIG. 5, at 514, the log-likelihood of the new parameters determined at step 608 are evaluated. If the log-likelihood is greater than the desired tolerance, the algorithm returns to step 512 and repeats expectation maximization. If the log likelihood is less than the desired tolerance, then the algorithm proceeds to the next step.

At 516, an optimal timing model is generated from the result of the Maximization Step 512. The optimal timing model leverages the novelty of the Gaussian Mixture Model to determine the most efficient signal timings.

At 518, once the model is generated and the optimal timings are determined, they can be applied to traffic signals. This ensures that the signals are synchronized with the actual traffic demands, leading to smoother transitions, fewer stops, and an overall more efficient transportation system.

In one form, the optimal timing model may include signal phase durations. The optimal timing model may include a recommended duration for each signal phase (typically, red, yellow, and green). In one form, the model may, during peak traffic hours, suggest extending the green phase for a primary road while shortening it for a less busy side street.

In one form, the optimal timing model may include signal coordination. For example, in the case of corridors with multiple signals, the model may recommend timings that ensure a series of green lights, or a “green wave.” This means that once a vehicle starts moving after a green signal, it encounters successive green signals, reducing the need to stop frequently.

In one form, the traffic volume estimating unit communicates the signal phase durations and signal coordination of the optimal timing model to a traffic signal controller to be applied to the traffic signals at an intersection. The traffic signal controller may be located at or near the intersection and may be communicatively coupled with the traffic signals at the intersection. Additionally or alternatively, the traffic signal controller may be included in the roadside unit 306. In such case, the roadside unit can control the traffic signal directly based on the optimal timing model.

In one form, the traffic volume estimating unit is communicatively coupled with the traffic signals at the intersection and applies the signal phase durations and signal coordination of the optimal timing model to the traffic signals.

The proposed model of the present disclosure may further include various feedback loops. Traffic patterns are dynamic and can change for many reasons, both foreseeable and unforeseeable. Continuous monitoring, using sensors 304, provides real-time data that can be used to assess the effectiveness of the timings and coordinations of the optimal timing model. Such feedback may be incorporated in future loops of the traffic volume estimation model.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

A module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

A module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of a module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method for traffic volume estimation using approaching vehicle data, comprising:
using, by a processor, an arrival traffic model to predict an arrival pattern of vehicles arriving at a traffic signal within a cycle;
applying, by the processor, an Expectation Maximization algorithm to the arrival traffic model at each cycle;
determining, by the processor, an optimal timing model of the traffic signal based on the arrival traffic model and the applied Expectation Maximization algorithm; and
wherein the traffic signal is controlled based on the optimal timing model.

2. The method of claim 1, wherein the vehicles are arriving at an intersection.

3. The method of claim 1, wherein the arrival traffic model comprises a Gaussian Mixture Model that provides a continuous representation of probability.

4. The method of claim 1, wherein the cycle may be a red cycle determined by a length of time that the traffic signal displays a red light, or a green cycle determined by a length of time that the traffic signal displays a green light.

5. The method of claim 1, wherein the arrival traffic model further comprises consideration for time of day, peak hours, and off-peak hours.

6. The method of claim 1, wherein applying the Expectation Maximization algorithm comprises an expectation step and a maximization step.

7. The method of claim 1, wherein the arrival traffic model is trained on partial or incomplete sensor data from at least one of an inductive loop detector, a video processing unit, and a passive or active infrared sensor.

8. A system comprising a processor and memory configured to:
use an arrival traffic model to predict an arrival pattern of vehicles arriving at a traffic signal within a cycle;
apply an Expectation Maximization algorithm to the arrival traffic model at each cycle;
determine an optimal timing model of the traffic signal based on the arrival traffic model and the applied Expectation Maximization algorithm; and
wherein a traffic signal is controlled based on the optimal timing model.

9. The system of claim 8, wherein the vehicles are arriving at an intersection associated with the traffic signal.

10. The system of claim 8, wherein the arrival traffic model comprises a Gaussian Mixture Model that provides a continuous representation of probability.

11. The system of claim 8, wherein the cycle may be a red cycle determined by a length of time that the traffic signal displays a red light, or a green cycle determined by a length of time that the traffic signal displays a green light.

12. The system of claim 8, wherein the arrival traffic model further comprises consideration for time of day, peak hours, and off-peak hours.

13. The system of claim 8, wherein applying the Expectation Maximization algorithm comprises an expectation step and a maximization step.

14. The system of claim 8, wherein the arrival traffic model is trained on partial or incomplete sensor data from at least one of an inductive loop detector, a video processing unit, and a passive or active infrared sensor.

15. A system comprising:
a processor; and
a nontransitory computer-readable medium including instructions that are executable by the processor, wherein the instructions include:
using, by the processor, an arrival traffic model to predict an arrival pattern of vehicles at a traffic signal within a cycle;
applying, by the processor, an Expectation Maximization algorithm to the arrival traffic model at each cycle;
determining, by the processor, an optimal timing model of the traffic signal based on the arrival traffic model and the applied Expectation Maximization algorithm; and
wherein the traffic signal is controlled based on the optimal timing model.

16. The system of claim 15, wherein the vehicles are arriving at an intersection associated with the traffic signal.

17. The system of claim 15, wherein the arrival traffic model comprises a Gaussian Mixture Model that provides a continuous representation of probability.

18. The system of claim 15, wherein the cycle may be a red cycle determined by a length of time that the traffic signal displays a red light, or a green cycle determined by a length of time that the traffic signal displays a green light.

19. The system of claim 15, wherein the arrival traffic model further comprises consideration for time of day, peak hours, and off-peak hours.

20. The system of claim 15, wherein applying the Expectation Maximization algorithm comprises an expectation step and a maximization step.
